(19) United States
(12) Patent Application Publication
(10) Pub. No.: US 2026/0309970 A1
(43) Pub. Date: Oct. 8, 2026

(54) METHOD FOR GENERATING A SUPER-RESOLVED RECONSTRUCTED IMAGE OF A FLUORESCENT SAMPLE AND STRUCTURED ILLUMINATION MICROSCOPY METHOD

(71) Applicant: CRESTOPTICS S.P.A., Roma RM (IT)

(72) Inventors: Raino CECCARELLI, Roma RM (IT); Fabrizio GALA, Roma RM (IT); Emanuele PONTECORVO, Roma RM (IT)

(73) Assignee: CRESTOPTICS S.P.A., Roma RM (IT)

(21) Appl. No.: 19/481,673

(22) PCT Filed: Apr. 4, 2024
(86) PCT No.: PCT/IB2024/053285

§ 371 Date: Nov. 5, 2025

(30) Foreign Application Priority Data
May 31, 2023 (IT) 102023000011106

(51) Int. Cl. G02B 21/36; G01N 21/64

(52) U.S. Cl. CPC G02B 21/367; G01N 21/6458

(57) ABSTRACT

A digital imaging process that can be used in structured illumination microscopy to obtain super-resolved images of samples having a distribution of fluorophores that emit light when illuminated by excitation light beams uses an innovative algorithm in which a super-resolved image, in a secant plane of the sample in which the excitation light beams are focused, is reconstructed also taking into account the light contributions coming from fluorophores located in out-of-focus planes. The digital image processing methods of this disclosure can be implemented through a program run by a computer and can be used in a related structured illumination microscopy method (SIM).

### TECHNICAL FIELD

The present disclosure relates generally to digital imaging methods and more particularly to a computer-implemented method for generating a super-resolved reconstructed image of a fluorescent sample as well as a structured illumination microscopy method.

### BACKGROUND

Two factors that deteriorate image resolution in fluorescence microscopy are noise and diffraction. The blurring of an object caused by the Abbe diffraction limit is mathematically described as a convolution of this object with the Point Spread Function (PSF) of the microscope, which is limited in bandwidth to spatial frequencies less than 2 NA/λ (where λ is the fluorescence wavelength and NA is the numerical aperture of the microscope objective).

To date, there are many optical microscopy techniques that allow the resolution limit imposed by the diffraction of light to be overcome; some of these super-resolution methods use a multi-spot “structured” light, for illuminating a sample, which exploits the physical phenomenon of beating to acquire information otherwise impossible to obtain in a normal microscopy apparatus. Many of these methods require ad hoc algorithmic processing of the data collected to obtain the final super-resolved image, that is, one with double the resolution compared to images obtained with traditional microscopy systems. Structured illumination microscopy (SIM) relies on excitation of a sample with a known spatial pattern of lights. Several images are acquired and a super resolution image is obtained.

In modern microscopy, structured illumination microscopy (SIM) can be used to examine single cells using spatially distributed light to excite fluorescence from the sample which is subsequently detected. One or more images are processed to produce a super-resolution image with twice the resolution of a conventional wide-field microscope image.

Among the various ways of structuring light to illuminate a distribution of fluorophores on a sample to be observed, there is that of using light focused through a grating of microlenses, for example as illustrated in FIG. 1, to acquire a number N of images to be reconstructed appropriately through a processing algorithm. The N images differ by a translation of the mask which generates structured illumination, such that the entire field of view of the microscope is illuminated in a substantially uniform manner. In such microscopes, the light source illuminates the microlens grating, focusing the pattern of dots on the biological sample; the light emitted by the fluorophores present in the sample is then collected by a detector placed in a plane conjugated to that of the sample; this operation is replicated N times, shifting the pattern of illumination points in such a way as to obtain a series of dotted images.

The typical data reconstruction method for multi-spot structured light is based on a two-dimensional Bayesian deconvolution [1][2][3], in which an image formation model is used by an algorithm. A rigorous treatment from a mathematical point of view of the general ideas that lead to the reconstruction of two-dimensional super-resolution images with Bayesian deconvolution techniques is set out in [4]. If the N two-dimensional images acquired by the microscope were not corrupted by noise of any kind, then the generic two-dimensional image μⱼ(x,y), obtained by illuminating the distribution of fluorophores ρ_{f}(x,y) of the sample with the j-th distribution of light pⱼ(x,y) focused in a secant plane of the sample and generated by the j-th source of structured illumination used to observe the sample is given by the following formula:

$${μ}_{j} ( x , y ) = [ ( {ρ}_{f} \cdot {p}_{j} ) {⊗}_{2 d} {h}_{em}^{( 2 d )} ] ( x , y ) j ∈ \{ 1 , … , N \}$$

wherein the symbol ⊗_{2d} represents the convolution product in two-dimensional space and

$${h}_{em}^{( 2 d )}$$

is a transmission function in two dimensions of the system illuminated with monochromatic light of wavelength λ (or emission Point Spread Function). An example of a two-dimensional Point Spread Function (PSF) obtained with a microlens that focuses a light beam in a plane is represented in FIG. 2.

The generic j-th light distribution pⱼ(x,y) must be known a priori, through an appropriate calibration measurement, and can be schematized mathematically with the following formula

$${p}_{j} ( x , y ) = [ {m}_{j} {⊗}_{2 d} {h}_{ex}^{( 2 d )} ] ( x , y )$$

wherein mⱼ(x,y) it is a generic j-th two-dimensional illumination mask placed in the plane conjugated to that of the camera and

$${h}_{ex}^{( 2 d )}$$

is a two-dimensional excitation Point Spread Function (PSF).

As explained in [4], what is detected by the microscope is not the image μⱼ(x,y) but a version of it dⱼ(x,y) corrupted by noise:

Once the N images dⱼ(x,y) have been captured with the microscope, as explained in [4], an iterative procedure based on the maximum likelihood (MV) method is applied to estimate iteratively the distribution ρ_{f} according to the following formula:

$${ρ}_{f}^{( k + 1 )} = [ {\sum }_{j} ( \frac{{d}_{j}}{{μ}_{j}^{( k )}} {⊗}_{2 d} {h}_{em}^{( 2 d ) t} ) \cdot {p}_{j} ] \cdot {ρ}_{f}^{( k )}$$

by imposing the condition

$${\sum }_{j} {p}_{j} = 1$$

wherein

$${h}_{em}^{( 2 d ) t}$$

is the operator transposed with respect to the emission PSF

$${h}_{em}^{( 2 d )} .$$

If we assume (see [4]) that the noise has a mixed probability distribution function between the Poisson probability distribution, which models an impulsive noise (shot noise), and the Gaussian probability distribution with variance σ², which models a noise Gaussian generated by the microscope that captures the light, according to the following formula:

$$P ( {d}_{i} \vert {μ}_{i} , {σ}^{2} ) = \frac{{e}^{- ( {μ}_{i} + {σ}^{2} )} \cdot {( {μ}_{i} + {σ}^{2} )}^{( {d}_{i} + {σ}^{2} )}}{Γ ( {d}_{i} + {σ}^{2} + 1 )}$$

thus it is possible to use the following formula:

$${ρ}_{f}^{( k + 1 )} = [ {\sum }_{j} ( \frac{{d}_{j} + {σ}^{2}}{{μ}_{j}^{( k )} + {σ}^{2}} {⊗}_{2 d} {h}_{em}^{( 2 d ) t} ) \cdot {p}_{j} ] \cdot {ρ}_{f}^{( k )} ≡ {\hat{\prod }}_{0}^{( k )} \cdot {ρ}_{f}^{( k )}$$

In general, an iterative formula of this type is used:

$${ρ}_{f}^{( k + 1 )} = {\hat{\prod }}_{0}^{( k )} \cdot {ρ}_{f}^{( k )}$$

to calculate a new approximate distribution

$${ρ}_{f}^{( k + 1 )}$$

of the distribution ρ_{f} starting from the approximate distribution

$${ρ}_{f}^{( k )}$$

calculated in the previous step, wherein \hat{Π}₀^{(k)} is a two-dimensional update operator at the k-th step and is given by a summation of products between the generic distribution of light pⱼ focused in the sample plane and a respective two-dimensional convolution product involving the transposed operator

$${h}_{em}^{( 2 d ) t}$$

of the emission PSF

$${h}_{em}^{( 2 d )} .$$

A drawback of the method described above consists in the fact that it does not respect the energy conservation condition, i.e. not all the light collected by the microscope is considered in the algorithm. In fact, the generic captured image dⱼ(x,y) is of the type illustrated in FIG. 3, but in the algorithm only the part contained in the dotted circle is used, which has a diameter known a priori that expert technicians establish according to the size of the microlenses used and the microscope magnification. Since the reconstruction is carried out plane by plane and the operators used are all two-dimensional, the total energy of the detected photons can vary from one plane to another, which makes the images obtained difficult to interpret and compare. On the contrary, energy conservation is an advantage of the deconvolution algorithms commonly used in the processing of images obtained with various fluorescence microscopy techniques (widefield, confocal).

In general, a digital imaging process that can be used in microscopy to improve the quality of images produced of specimens having a distribution of fluorophores that emit light when illuminated by excitation light beams would be desirable.

### SUMMARY

The aforementioned limitations have been resolved, at least in part, with a computer-implemented method for generating a super-resolved reconstructed image as defined in claim 1. This excellent result has been achieved using an algorithm in which a super-resolved image, in a plane that passes through the sample on which the excitation light beams are focused, is reconstructed also taking into account the light contributions that come from fluorophores that are found in the out-of-focus planes, which are instead neglected in the algorithms described in [4].

The methods of this disclosure can be implemented through a program executed by a computer and can be used in a related structured illumination microscopy (SIM) method.

Further embodiments are defined in the attached claims.

### BRIEF DESCRIPTION OF THE DRAWINGS

FIG. 1 shows a microlens array for generating focused light in a structured illumination microscopy system.

FIG. 2 shows an example of a two-dimensional Point Spread Function (PSF) obtained with a microlens that focuses a beam of light in a plane.

FIG. 3 illustrates an image of a light spot in which the pixels intended to be processed in a digital pinholing algorithm are included in a dashed circle.

FIG. 4 shows an example of a three-dimensional Point Spread Function.

FIGS. 5a and 5b schematically illustrate the same illumination function p_{j,z}_{₀}(r) for different values of the coordinate z₀ of the secant plane in focus of the sample.

FIG. 6 illustrates a sample illuminated by excitation light beams focused in a secant plane passing through the sample, in which it is noted that the out-of-focus planes at a distance greater than

$$\frac{h}{NA}$$

are practically homogeneously illuminated.

FIGS. 7a, 7b and 7c show respectively a captured “widefield” image (FIG. 7a), the component in the in-focus plane (FIG. 7b) of the captured image and the component due to light coming from out-of-focus planes (FIG. 7c) of the captured image.

FIGS. 8a, 8b and 8c show three images obtainable through Singular Value Decomposition of N captured images.

FIGS. 9a, 9b and 9c represent super-resolved images, obtained after ten iterations, of the same fluorescent sample with RFP fluorophores respectively according to the method of the present disclosure (FIG. 9a), according to a known method with digital pinholing of 6 pixels (FIG. 9b) and according to a known method with digital pinholing of 10 pixels (FIG. 9c), in which the lateral dimension of the pixel is 32.5 nm and the images are obtained with a magnification of 100× and a wavelength λ of 561 nm.

FIGS. 10a, 10b and 10c show a progressive reduction in the likelihood value as the number of iterations increases to obtain the images of FIGS. 9a, 9b and 9c respectively.

FIGS. 11a and 11b show pixel light intensity diagrams of the elements highlighted with a dashed oval in FIGS. 9a and 9b, respectively.

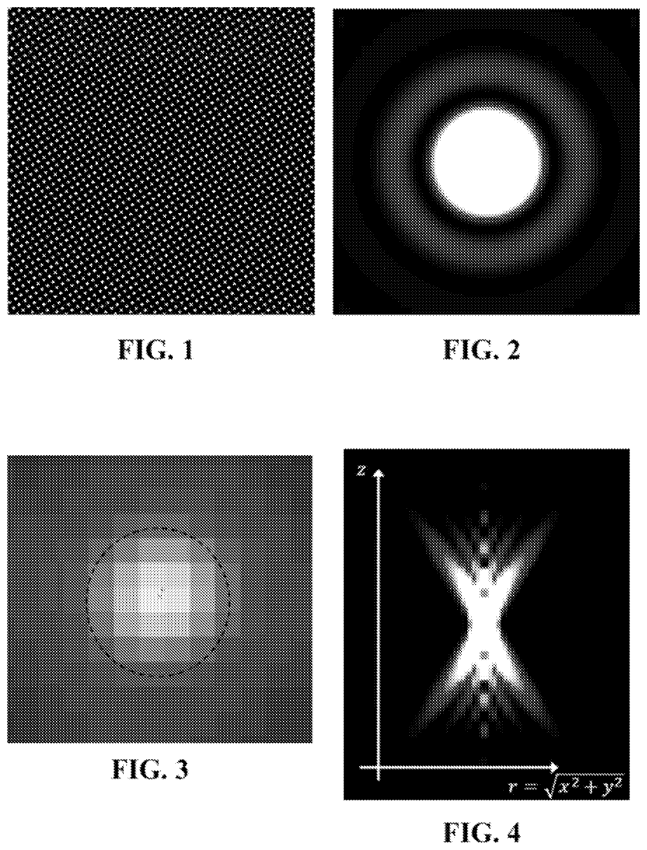

### DESCRIPTION OF ILLUSTRATIVE EMBODIMENTS

The processing carried out plan by plan using only two-dimensional operators involves only the information coming from the single focused plane, neglecting all that information coming from out-of-focus planes and which could potentially lead to a higher quality of the processed image in terms of contrast or resolution. Considering the excitation/emission PSFs as purely two-dimensional simplifies the numerical processing, but these PSFs are three-dimensional, as shown for example in FIG. 4 in the case corresponding to FIG. 2 where NA=1.4, λₑₘ=510 nm and n₁=1.518. By constructing the three-dimensional PSF of FIG. 4 with the focus in z=0, the two-dimensional PSF of FIG. 2 is obtained, i.e. h^{(3d)}(x,y,0)=h^{(2d)}(x,y). The two-dimensional model therefore does not satisfactorily represent what happens in reality as there are values relating to out-of-focus planes that are not considered in the calculation and this limits the accuracy of the super-resolved image that can be reconstructed with the algorithm iterative.

A difficulty in defining an iterative algorithm on three-dimensional space consists in the fact that, even if the illumination is focused in a generic z₀ plane, it still has a distribution in three-dimensional space and can be described by the formula:

$${p}_{j , {z}_{0}} ( r ) ≡ {p}_{j , {z}_{0}} ( x , y , z ) ≡ {p}_{j} ( x , y , z ; {z}_{0} ) = [ {m}_{j} ( {x}^{′} , {y}^{′} ) \cdot δ ( {z}^{′} - {z}_{0} ) {⊗}_{3 d} {h}_{ex}^{( 3 d )} ] ( x , y , z )$$

Wherein x′, y′, z′ are the silent variables to carry out the convolution product mⱼ(x,y), is the generic two-dimensional mask placed in the plane conjugated to that of the camera and the excitation PSFs are constructed with the focus in z=0, i.e. so as h^{(3d)}(x,y,0)=h^{(2d)}(x,y).

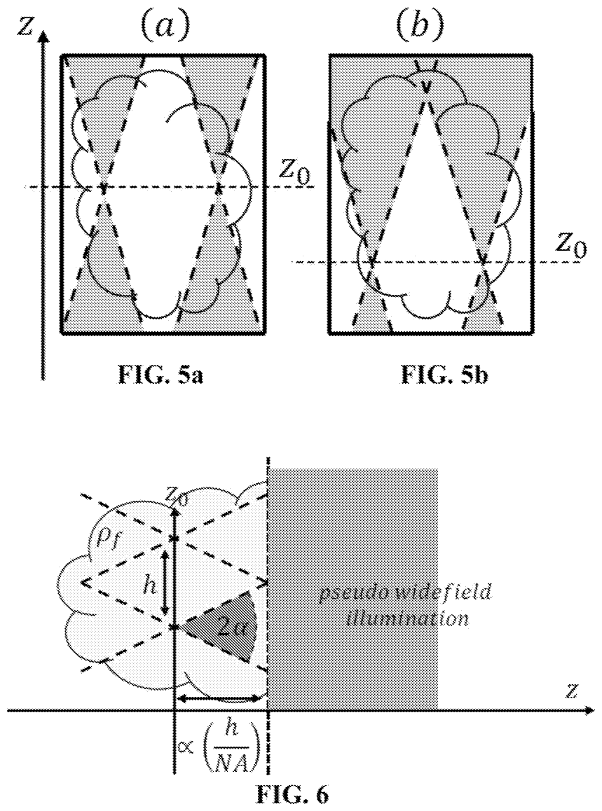

FIG. 5a illustrates the illumination function p_{j,z}_{₀}(r) of a sample to be analyzed (represented as a cloud) when the in-focus plane z₀ is halfway with respect to the chamber plane and the conjugate plane, while FIG. 5b illustrates the same function when the plane a focus z₀ is closest to the plane conjugated to that of the chamber. Clearly, the values in the three-dimensional space of the function p_{j,z}_{₀}(r) change as the z₀ coordinate of the plane in focus varies and the image obtained also changes, since as the z₀ coordinate varies, the way in which the sample is illuminated changes.

According to this disclosure, the quality of the super-resolved image reconstructed starting from an image captured by an acquisition device is improved, using an iterative algorithm formulated starting from a three-dimensional model of the type.

$${μ}_{j} ( x , y , {z}_{0} ) = [ ( {ρ}_{f} \cdot {p}_{j , {z}_{0}} ) {⊗}_{3 d} {h}_{em}^{( 3 d )} ] ( x , y , {z}_{0} )$$

which can allow to resolve, at least partially, some of the above-mentioned drawbacks of the traditional reconstruction algorithms for the focused light SIM. The simple modification of the image model from two to three dimensions allows the contributions of the out-of-focus planes to be included exactly and therefore allows the counts of the out-of-focus contributions to be reallocated to the planes from which they really come.

What is detected by the microscope is not the image μⱼ(x, y, z₀) but a version of it dⱼ(x, y, z₀) corrupted by noise, so the minimization rule necessary to obtain the final super-resolved image, through a three-dimensional iterative algorithm of the type illustrated in [4], should be rewritten as follows:

$${ρ}_{f}^{( k + 1 )} ( r ) = {ρ}_{f}^{( k )} ( r ) [ {\sum }_{j} ( \int {d}^{3} {r}^{′} \frac{{d}_{j} ( {r}^{′} )}{{μ}_{j}^{( k )} ( {r}^{′} )} \cdot {χ}_{j} ( {r}^{′} , r ) ) ]$$

$${χ}_{j} ( {r}^{′} , r ) = {p}_{j} ( r ; {z}^{′} ) {h}_{em}^{( 3 d ) t} ( r - {r}^{′} )$$

$$wherein$$

$${p}_{j} ( r ; {z}^{′} ) ≡ {p}_{j , {z}^{′}} ( r ) ;$$

$$\int {d}^{3} {r}^{′} {\sum }_{j} {χ}_{j} ( {r}^{′} , r ) = 1 ;$$

$$and wherein :$$

$${μ}_{j}^{( k )} ( x , y , {z}_{0} ) = [ ( {ρ}_{f}^{( k )} \cdot {p}_{j , {z}_{0}} ) {⊗}_{3 d} {h}_{em}^{( 3 d )} ] ( x , y , {z}_{0} ) .$$

An advantage of these formulas consists in the fact that the digital pinholing operation is no longer necessary when dealing with experimental data dⱼ, but the function Xⱼ(r′,r) does not allow the expression to be rewritten in the form of a convolution product, making its numerical implementation particularly onerous for relatively low cost hardware devices.

Assuming that each image captured by the microscope is corrupted both by “shot noise” (Poisson probability distribution) and by Gaussian noise of the camera, the generic captured image dⱼ is given by:

$${d}_{j} ∼ ℘ ( {μ}_{j} ) + n$$

Wherein n is a Gaussian noise having a standard deviation σ, and ρ( . . . ) is an implementation of a Poisson process having an average μⱼ. The likelihood function L[ρ_{f}] to be minimized is given by the following formula

$$L [ {ρ}_{f} ] = {\sum }_{j} \int \int \int dxdydz [ ( {μ}_{j} [ {ρ}_{f} ] + {σ}^{2} ) - ( {d}_{j} + {σ}^{2} ) log ( {μ}_{j} [ {ρ}_{f} ] + {σ}^{2} ) + log ( Γ ( {d}_{j} + {σ}^{2} + 1 ) ) ]$$

and its iterative minimization allows to reconstruct the super-resolved fluorophore distribution:

$${\hat{ρ}}_{f} = {ρ}_{f}^{( k )} : L [ {ρ}_{f}^{( k )} ] = {min}_{{ρ}_{f}} L [ {ρ}_{f} ]$$

To calculate the distribution that minimizes the likelihood function, the following formula can be used:

$${ρ}_{f}^{( k + 1 )} ( r ) = [ {\sum }_{j} \int {d}^{3} {r}^{′} ( \frac{{d}_{j} ( {r}^{′} ) + {σ}^{2}}{{μ}_{j}^{( k )} ( {r}^{′} ) + {σ}^{2}} ) {χ}_{j} ( {r}^{′} , r ) ] {ρ}_{f}^{( k )} ( r ) ≡ {\hat{\prod }}^{( k )} ( r ) {ρ}_{f}^{( k )} ( r )$$

$$wherein$$

$${χ}_{j} ( {r}^{′} , r ) ≡ \frac{{δμ}_{j} ( {r}^{′} )}{{δρ}_{f} ( r )} = {p}_{j} ( r ; {z}^{′} ) {h}_{em}^{( 3 d ) t} ( r - {r}^{′} )$$

$$\int {d}^{3} {r}^{′} {\sum }_{j} {χ}_{j} ( {r}^{′} , r ) = 1$$

$$with {r}^{′} = ( {x}^{′} , {y}^{′} , {z}^{′} ) and r = ( x , y , z ) .$$

According to this disclosure, the three-dimensional distribution of fluorophores of a super-resolved image is calculated with an iterative algorithm in which a three-dimensional distribution of fluorophores at the (k+1)-th step is obtained by multiplying the three-dimensional distribution of fluorophores at the k-th step for a k-th three-dimensional operator \hat{└}^{(k)}(r) given by the following formula:

$${\sum }_{j} \int {d}^{3} {r}^{′} ( \frac{{d}_{j} ( {r}^{′} ) + {σ}^{2}}{{μ}_{j}^{( k )} ( {r}^{′} ) + {σ}^{2}} ) {p}_{j} ( r ; {z}^{′} ) {h}_{em}^{( 3 d ) t} ( r - {r}^{′} ) ≡ {\hat{\prod }}^{( k )} ( r )$$

Wherein

$${μ}_{j}^{( k )}$$

is the three-dimensional image corresponding to the k-th distribution of fluorophores

$${ρ}_{f}^{( k )}$$

and is given by

$${μ}_{j}^{( k )} ( x , y , {z}_{0} ) = [ ( {ρ}_{f}^{( k )} \cdot {p}_{j , {z}_{0}} ) {⊗}_{3 d} {h}_{em}^{( 3 d )} ] ( x , y , {z}_{0} ) .$$

An advantage of the iterative algorithm described above consists in the fact that, in the case in which the Gaussian noise of the microscope is negligible (σ=0), the number of total counts is constant for each iteration and is equal to:

$$\int {d}^{3} r {ρ}_{f}^{( k )} ( r ) = \int {d}^{3} r {\sum }_{j} {d}_{j} ( r ) = c ∀ k .$$

This means that the number of photons emitted by the illuminated sample remains constant at each iteration. Furthermore, with this algorithm the image obtained relating to each z plane does not only depend on the PSF values relating to that same plane, but also depends on the illumination of other planes.

The three-dimensional algorithm of this disclosure requires a higher computational burden due to the function p_{j,z}_{₀}(r)≡pⱼ(r;z₀) which is the structured and focused lighting in the plane conjugated to z₀. However, it can be simplified to perform only two-dimensional convolution products, which are easier to perform with low-cost hardware devices.

According to one aspect, the k-th three-dimensional update operator \hat{└}^{(k)}(r) can be approximated by linearizing piecewise in amplitude Δz_{M} the convolution integral along the z axis in a finite interval centered around the focus plane z₀, as the sum of a first term \hat{└}₀^{(k)} in the plane in focus z₀ and a second term δ\hat{└}^{(k)} relating to planes out of focus:

$${\hat{\prod }}^{( k )} ≃ {\hat{\prod }}_{0}^{( k )} + δ {\hat{\prod }}^{( k )}$$

wherein

$${\hat{\prod }}_{0}^{( k )} + δ {\hat{\prod }}^{( k )} ≃ Δ {z}_{M} [ {\sum }_{j} ( \frac{{d}_{j} \{ {z}_{0} \} + {σ}^{2}}{{μ}_{j}^{( k )} \{ {z}_{0} \} + {σ}^{2}} {⊗}_{2 d} {h}_{em}^{( 3 d ) t} \{ 0 \} ) \cdot {p}_{j , {z}_{0}} \{ {z}_{0} \} ] + Δ {z}_{M} [ {\sum }_{n \neq 0} {\sum }_{j} ( \frac{{d}_{j} \{ {z}_{n} \} + {σ}^{2}}{{μ}_{j}^{( k )} \{ {z}_{n} \} + {σ}^{2}} {⊗}_{2 d} {h}_{em}^{( 3 d ) t} \{ {z}_{0} - {z}_{n} \} ) \cdot {p}_{j , {z}_{n}} \{ {z}_{0} \} ]$$

and wherein

$${d}_{j} \{ ζ \} ≡ {d}_{j} ( x , y , ζ ) , {μ}_{j}^{( k )} \{ ζ \} ≡ {μ}_{j}^{( k )} ( x , y , ζ ) , \\ {h}_{em}^{( 3 d ) t} \{ ζ \} ≡ {h}_{em}^{( 3 d ) t} ( x , y , ζ ) , {p}_{j , z} \{ ζ \} ≡ {p}_{j , z} ( x , y , ζ ) .$$

The first term \hat{└}₀^{(k)} of the k-th update operator \hat{└}^{(k)}(r) is two-dimensional and is referred to the in-focus plane z₀, while the second two-dimensional term δ\hat{└}^{(k)} contains the contributions of the out-of-focus planes zₙ.

According to one aspect, one can restrict the convolution integral along the z axis to a width L_{z} centered on the focus plane z₀ of the transposed operator

$${h}_{em}^{( 3 d ) t}$$

of the three-dimensional emission PSF, by piecewise linearizing the integral along the z axis in 2M pieces of width Δz_{M} wherein

$$Δ {z}_{M} = \frac{{L}_{z}}{2 M} .$$

In this case the computational burden is further reduced, but with this approximation the total number of photons counted for each plane will only be approximately the same for all planes.

According to one aspect, as an alternative, or even in addition, to the simplification of the update operator at the k-th step, the formula, with which the three-dimensional image

$${μ}_{j}^{( k )}$$

corresponding to the k-th distribution of fluorophores

$${ρ}_{f}^{( k )}$$

is calculated, can be simplified

$${μ}_{j}^{( k )} ( x , y , {z}_{0} ) = [ ( {ρ}_{f}^{( k )} \cdot {p}_{j , {z}_{0}} ) {⊗}_{3 d} {h}_{em}^{( 3 d )} ] ( x , y , {z}_{0} ) ≅ [ ( {ρ}_{f}^{( k )} \{ {z}_{0} \} \cdot {p}_{j , {z}_{0}} ) {⊗}_{2 d} {h}_{em}^{( 2 d )} ] ( x , y , {z}_{0} ) + {I}_{j}^{oof ( k )} ( x , y , {z}_{0} )$$

$$wherein$$

$${I}_{j}^{oof ( k )} ( x , y , {z}_{0} ) = {\sum }_{\begin{matrix}n = - ∞ \\ n \neq 0\end{matrix}}^{+ ∞} [ ( {ρ}_{f}^{( k )} \{ {z}_{n} \} \cdot {p}_{j , {z}_{0}} \{ {z}_{n} \} ) {⊗}_{2 d} {h}_{em}^{( 3 d )} \{ {z}_{0} - {z}_{n} \} ] ( x , y , {z}_{0} )$$

With this approximation, the functional form of the minimization algorithm returns to that of the two-dimensional case, with the difference that now the out-of-focus contribution is explicitly added to the image model μⱼ.

According to one aspect, the calculation of the out-of-focus contribution

$${I}_{j}^{oof ( k )} ( x , y , {z}_{0} )$$

can be further simplified as the greatest contribution to the total of the summation comes from those planes for which the lighting is no longer considered focused, but can be considered practically homogeneous and therefore independent of the index j:

$${I}_{j}^{oof ( k )} ( x , y , {z}_{0} ) ≃ {I}^{oof ( k )} ( x , y , {z}_{0} ) ∀ j$$

Referring to FIG. 6, it can be seen that, indicating with h the distance between the foci of the light sources and with NA the numerical aperture of the focusing objective, the out-of-focus planes which are separated from the in-focus plane by a distance approximately equal to

$$\frac{h}{NA}$$

are practically illuminated in a homogeneous manner. With this approximation, the contribution of the out-of-focus planes to determine the k-th image

$${μ}_{j}^{( k )}$$

does not have to be recalculated for all j sources and this further reduces the computational burden.

According to one aspect, the calculation of the out-of-focus contribution can be further simplified by assuming that the link between the acquired image and the out-of-focus contribution is of the type:

$${d}_{j} ∼ {p}_{j} {I}^{if} + {I}^{oof}$$

$$wherein :$$

$${I}^{oof} = \frac{{\sum }_{j} {p}_{j}^{2} {\sum }_{j} {p}_{j} ( 1 - {p}_{j} )}{N {\sum }_{j} {p}_{j}^{2} - {( {\sum }_{j} {p}_{j} )}^{2}} [ \frac{{\sum }_{j} ( 1 - {p}_{j} ) {d}_{j}}{{\sum }_{j} {p}_{j} ( 1 - {p}_{j} )} - \frac{{\sum }_{j} {p}_{j} {d}_{j}}{{\sum }_{j} {p}_{j}^{2}} ]$$

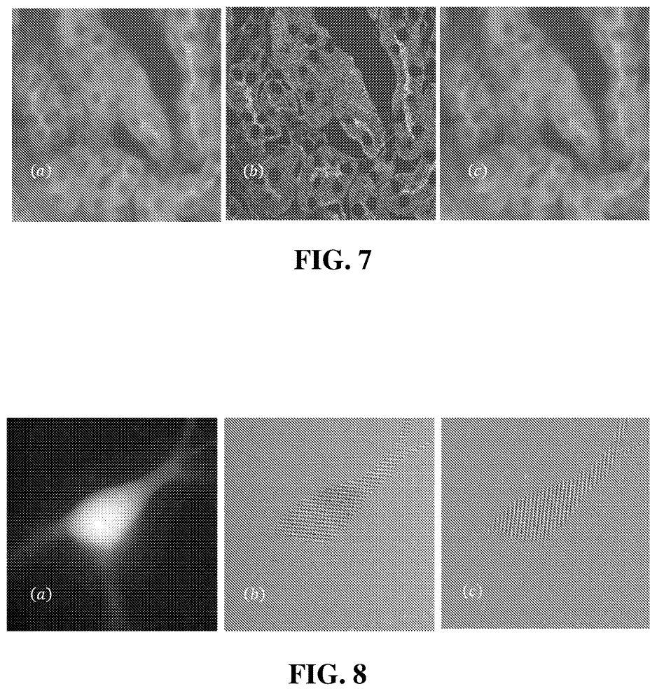

and an example of such decomposition is shown in FIGS. 7a, 7b and 7c which respectively show a captured widefield image (FIG. 7a), the in-focus component (FIG. 7b) and the out-of-focus component (FIG. 7c) of the captured image.

According to one aspect, the contribution of the out-of-focus light can be calculated from the acquired images dⱼ through an SVD (“Singular Value Decomposition”) in order to separate the part common to all N acquired images and define this common part as out-of-focus light.

To do this, each image dⱼ(x,y) is placed in a row of a matrix A, wherein j essentially becomes the row index.

$$A = [ \begin{matrix}{d}_{1} \\ {d}_{2} \\ … \\ {d}_{N}\end{matrix} ]$$

which is then decomposed as:

$$A = U \cdot \sum \cdot {V}^{*}$$

$$\sum = [ \begin{matrix}{σ}_{0} & … & 0 \\ ⋮ & ⋱ & ⋮ \\ 0 & … & {σ}_{N - 1} \\ 0 & … & 0 \\ ⋮ & ⋱ & ⋮ \\ 0 & … & 0\end{matrix} ]$$

Where U is a unit matrix of size m×m, Σ is a rectangular diagonal matrix of size m×N, V_{*} is the conjugate transpose of a unit matrix V of size N×N, wherein m is the image size along the axis y. This decomposition allows to isolate in the image set {d₁, . . . , d_{N}} a common “static” background image and all the N acquired images. The left eigenvector corresponding to the values σ₀ is the desired background image (see FIG. 8a) up to a constant. In FIGS. 8b and 8c the images relating to the values σ₁ and σ₂ are represented for completeness.

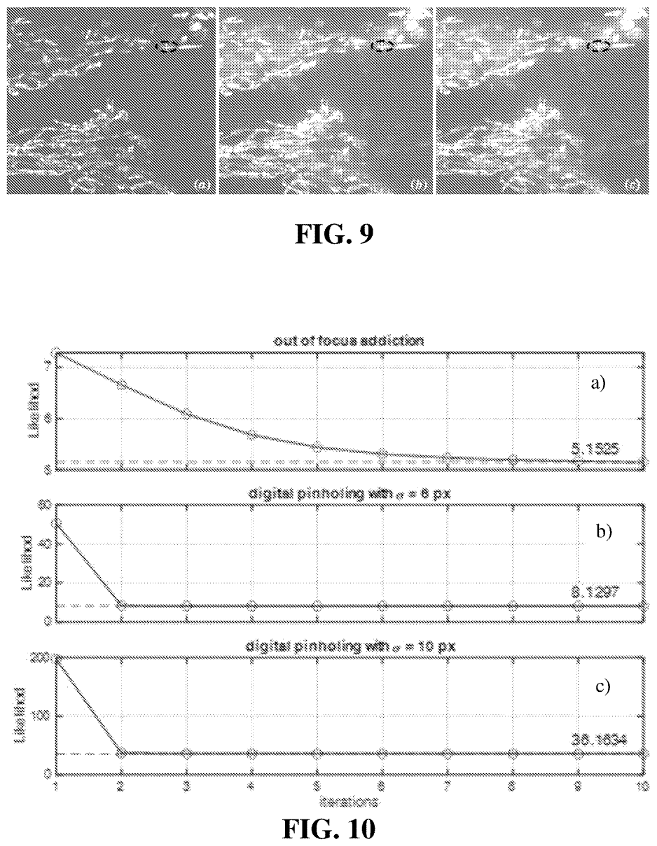

The performance of the method according to the present disclosure has been compared to that achievable through known 6-pixel and 10-pixel digital pinholing methods, and the results are illustrated in FIGS. 9a through 11b. FIGS. 9a, 9b and 9c respectively illustrate super-resolved images, obtained after ten iterations, of the same fluorescent sample with RFP fluorophores respectively according to the method of the present disclosure (FIG. 9a), according to a known method with digital pinholing of 6 pixels (FIG. 9b) and according to a known method with digital pinholing of 10 pixels. In FIG. 9a the elements of the fluorescent sample are clearly distinguishable in the focused plane compared to the dark background. Differently, in the images of FIGS. 9b and 9c of the same fluorescent sample, the elements in the in-focus plane are mixed with a distributed background brightness which does not allow their dimensions to be accurately determined. FIGS. 10a to 10c show the diagrams of the likelihood function as the number of iterations increases and demonstrate that the method of the present disclosure is generally characterized by levels of the likelihood function largely lower than those achievable with the known methods of digital pinholing of 6 pixels and 10 pixels. This excellent result is due to the fact that in the method of the present disclosure the intensity values of the in-focus plane are calculated also taking into account the contributions coming from out-of-focus fluorophores, so an image is obtained with a significantly better definition which allows to determine precisely the size of the depicted elements.

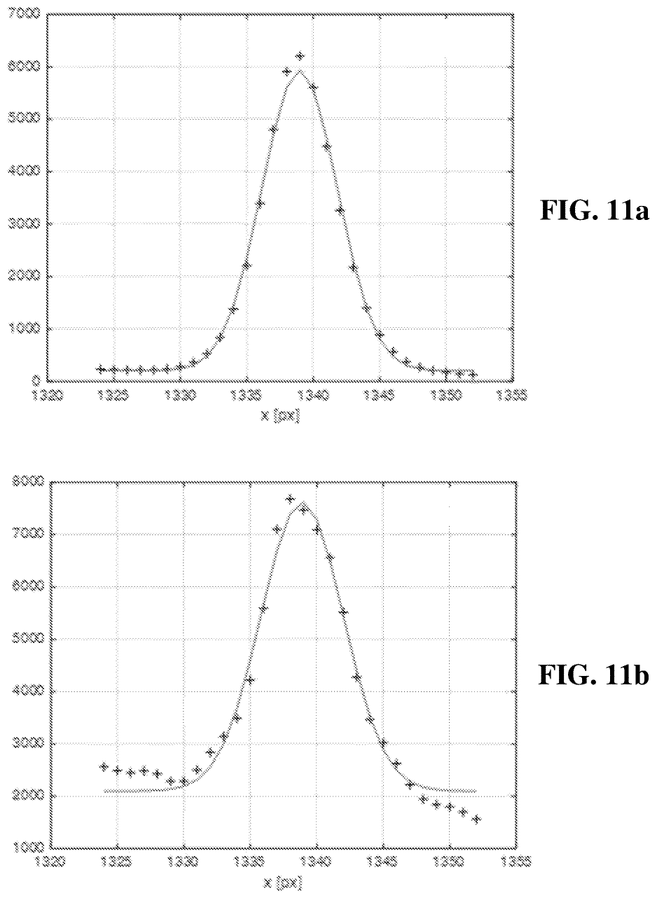

FIGS. 11a and 11b respectively illustrate the light intensity distributions of the element highlighted with a dashed oval in FIGS. 9a and 9b. One immediately notices that the light intensities of the pixels of the image in FIG. 9a are distributed in such a way as to allow the highlighted element to be clearly distinguished from the dark background, whereas (FIG. 11b) the same element is represented in FIG. 9b on a brightness distributed at the bottom.

Any variations or additions can be made by experts in the technical field to the embodiments described and illustrated here, while remaining within the scope of the following claims. In particular, further embodiments may include the technical characteristics of one of the following claims with the addition of one or more technical characteristics described in the text or illustrated in the figures, taken individually or in any reciprocal combination.

### REFERENCES

[1] York A. G. et al—“Resolution doubling in live, multicellular organisms via multifocal structured illumination microscopy”, Nature methods, Vol. 9, No. 7, p. 749-754 (2012).
[2] Ströhl F. et al—“A joint Richardson—Lucy deconvolution algorithm for the reconstruction of multifocal structured illumination microscopy data”, Methods Appl. Fluoresc. 3 (2015) 014002.
[3] Ingaramo, M. et al.—“Richardson-Lucy deconvolution as a general tool for combining images with complementary strengths”, ChemPhysChem, Vol. 15, No. 4, p. 794-800, (2014).
[4] Chakrova N. et al.—“Deconvolution methods for structured illumination microscopy”, Journal of the Optical Society of America A, Vol. 33, No. 7, p. B12-B20 (2016).

1. A computer-implemented method of generating a super-resolution reconstructed image of a fluorescent sample comprising fluorophores that emit light when illuminated with an excitation light beam, wherein said sample is illuminated with a plurality of excitation light beams focused in a secant plane traversing said sample to excite at least part of said sample fluorophores, said method comprising the following steps:
providing a plurality of N two-dimensional images dⱼ in a secant plane traversing said sample wherein each two-dimensional image dⱼ in said secant plane of said plurality of images was captured by illuminating said fluorescent sample with a corresponding j-th beam of excitation light focused in said secant plane,
being known a generic distribution of light intensity p_{j,z′}=pⱼ(r;z′) irradiated in three-dimensional space r by each excitation light beam focused in a generic secant plane of coordinate z′ and being known a three-dimensional emission Point Spread Function
$${h}_{em}^{( 3 d )} ( r )$$
and a corresponding three-dimensional transposed Point Spread Function
$${h}_{em}^{( 3 d ) t} ( r )$$
of the excited fluorophores of the sample, iteratively computing an approximate three-dimensional distribution of fluorophore
$${ρ}_{f}^{( k + 1 )} ( r )$$
at a (k+1)-th iteration step as the product of a k-th three-dimensional update operator \hat{└}^{(k)}(r) and an approximate three-dimensional distribution of fluorophores
$${ρ}_{f}^{( k )} ( r )$$
at a (k)-th iteration step:
$${ρ}_{f}^{( k + 1 )} ( r ) ≡ {\hat{\prod }}^{( k )} ( r ) {ρ}_{f}^{( k )} ( r )$$
wherein the k-th three-dimensional update operator \hat{└}^{(k)}(r) is given by
$${\sum }_{j} \int {d}^{3} {r}^{′} ( \frac{{d}_{j} ( {r}^{′} ) + {σ}^{2}}{{μ}_{j}^{( k )} ( {r}^{′} ) + {σ}^{2}} ) {p}_{j} ( r ; {z}^{′} ) {h}_{em}^{( 3 d ) t} ( r - {r}^{′} ) ≡ {\hat{\prod }}^{( k )} ( r ) ,$$
wherein σ² is a variance of a Gaussian noise and where a reconstructed k-th two-dimensional image
$${μ}_{j}^{( k )} ( x , y , {z}_{0} )$$
in a secant plane of coordinate z₀, which ideally would be obtained from the approximate three-dimensional distribution of the fluorophores
$${ρ}_{f}^{( k )} ( r )$$
determined at a generic k-th iteration step by focusing the j-th beam of excitation light in said secant plane of coordinate z₀ which passes through said sample, is given by:
$${μ}_{j} [ {ρ}_{f}^{( k )} ] ≡ {μ}_{j}^{( k )} ( x , y , {z}_{0} ) = [ ( {ρ}_{f}^{( k )} \cdot {p}_{j , {z}_{0}} ) {⊗}_{3 d} {h}_{em}^{( 3 d )} ] ( x , y , {z}_{0} )$$
wherein ⊗_{3d} denotes a convolution product in three-dimensional space;
determining a final three-dimensional distribution of the fluorophores \hat{ρ}_{f} as an approximate three-dimensional distribution of the fluorophore
$${ρ}_{f}^{( k )} ( r )$$
at a generic k-th iteration step minimizing a maximum likelihood function calculated as:
$$L [ {ρ}_{f} ] = {\sum }_{j} \int \int \int dxdydz [ ( {μ}_{j} [ {ρ}_{f} ] + {σ}^{2} ) - ( {d}_{j} + {σ}^{2} ) log ( {μ}_{j} [ {ρ}_{f} ] + {σ}^{2} ) + log ( Γ ( {d}_{j} + {σ}^{2} + 1 ) ) ] ;$$
generating with said computer a file of a super-resolution reconstructed image of said sample as a summation of reconstructed images μⱼ[\hat{ρ}_{f}] for each j-th beam of focused excitation light which theoretically would be obtained from the final three-dimensional distribution of fluorophores \hat{ρ}_{f}, in which each reconstructed image μⱼ[\hat{ρ}_{f}] is obtained as:
$${μ}_{j} [ {\hat{ρ}}_{f} ] = [ ( {\hat{ρ}}_{f} \cdot {p}_{j , {z}_{0}} ) {⊗}_{3 d} {h}_{em}^{( 3 d )} ] .$$

2. The method according to claim 1, comprising the operation of:
approximating said k-th three-dimensional update operator \hat{Π}^{(k)}(r) as the sum of a first two-dimensional term \hat{Π}₀^{(k)} relating to a secant plane in focus z₀ and a second two-dimensional term δ\hat{Π}^{(k)} relating to secant planes out of focus zₙ,
\hat{Π}^{(k)}≃\hat{└}₀^{(k)}+δ\hat{└}^{(k)}
wherein
$${\hat{Π}}_{0}^{( k )} ≃ Δ {z}_{M} [ {\sum }_{j} ( \frac{{d}_{j} \{ {z}_{0} \} + {σ}^{2}}{{μ}_{j}^{( k )} \{ {z}_{0} \} + {σ}^{2}} {⊗}_{2 d} {h}_{em}^{( 3 d ) t} \{ 0 \} ) \cdot {p}_{j , {z}_{0}} \{ {z}_{0} \} ]$$
$$δ {\hat{Π}}^{( k )} ≃ Δ {z}_{M} [ {\sum }_{n \neq 0} {\sum }_{j} ( \frac{{d}_{j} \{ {z}_{n} \} + {σ}^{2}}{{μ}_{j}^{( k )} \{ {z}_{n} \} + {σ}^{2}} {⊗}_{2 d} {h}_{em}^{( 3 d ) t} \{ {z}_{0} - {z}_{n} \} ) \cdot {p}_{j , {z}_{n}} \{ {z}_{0} \} ]$$
and wherein Δz_{M} is a piecewise linearization step.

3. The method according to claim 2, wherein said piecewise linearization step Δz_{M} is determined as the ratio between a width L_{z} of said transposed three-dimensional Point Spread Function
$${h}_{em}^{( 3 d ) t}$$
centered on the secant plane in focus z₀, and a number 2M of linearization pieces:
$$Δ {z}_{M} = \frac{{L}_{z}}{2 M} .$$

4. The method according to claim 1 comprising the operation of:
approximating said k-th two-dimensional reconstructed image
$${μ}_{j}^{( k )} ( x , y , {z}_{0} )$$
as the sum of a first term, due to the fluorophores lying in said in-focus secant plane having coordinate z₀, and of a second term due
$${I}_{j}^{oof ( k )} ( x , y , {z}_{0} )$$
to the fluorophores lying in out-of-focus secant planes having coordinate zₙ:
$${μ}_{j}^{( k )} ( x , y , {z}_{0} ) = [ ( {ρ}_{f}^{( k )} \cdot {p}_{j , {z}_{0}} ) {⊗}_{3 d} {h}_{em}^{( 3 d )} ] ( x , y , {z}_{0} ) ≅ [ ( {ρ}_{f}^{( k )} \{ {z}_{0} \} \cdot {p}_{j , {z}_{0}} ) {⊗}_{2 d} {h}_{em}^{( 2 d )} ] ( x , y , {z}_{0} ) + {I}_{j}^{oof ( k )} ( x , y , {z}_{0} )$$
wherein ⊗_{2d} denotes a convolution product in a two-dimensional image plane and wherein
$${h}_{em}^{( 2 d )}$$
is a two-dimensional Point Spread Function obtained from said three-dimensional Point Spread Function
$${h}_{em}^{( 3 d )} as : {h}_{em}^{( 3 d )} ( {x}^{′} , {y}^{′} , 0 ) ≡ {h}_{em}^{( 2 d )} ( {x}^{′} , {y}^{′} )$$
and wherein
$${I}_{j}^{oof ( k )} ( x , y , {z}_{0} ) = {{{\sum }_{n = - ∞}}^{+ ∞}}_{n \neq 0} [ ( {ρ}_{f}^{( k )} ( {x}^{′} , {y}^{′} , {z}_{n} ) \cdot {p}_{j , {z}_{0}} ( {x}^{′} , {y}^{′} , {z}_{n} ) {⊗}_{2 d} {h}_{em}^{( 3 d )} ( {x}^{′} , {y}^{′} , {z}_{0} - {z}_{n} ) ] ( x , y , {z}_{0} ) .$$

5. The method according to claim 4, comprising the operation of: approximating said second term
$${I}_{j}^{oof ( k )} ( x , y , {z}_{0} )$$
with a third term I^{oof(k)}(x, y, z₀) that is the same for all excitation light beams:
$${I}_{j}^{oof ( k )} ( x , y , {z}_{0} ) ≃ {I}^{oof ( k )} ( x , y , {z}_{0} ) ∀ j .$$

6. The method according to claim 5, comprising the operation of: determining said third term I^{oof(k)}(x, y, z₀) constant at each k-th iteration step as:
$${I}_{j}^{oof ( k )} ≡ {I}^{oof} = \frac{{\sum }_{j} {p}_{j}^{2} {\sum }_{j} {p}_{j} ( 1 - {p}_{j} )}{N {\sum }_{j} {p}_{j}^{2} - {( {\sum }_{j} {p}_{j} )}^{2}} \cdot [ \frac{{\sum }_{j} ( 1 - {p}_{j} ) {d}_{j}}{{\sum }_{j} {p}_{j} ( 1 - {p}_{j} )} - \frac{{\sum }_{j} {p}_{j} {d}_{j}}{{\sum }_{j} {p}_{j}^{2}} ]$$
wherein N is a number of said excitation light beams,
wherein pⱼ is the luminous intensity distribution pⱼ(x, y, z₀; z₀) of the j-th excitation light beam in the focus plane with coordinate z₀,
wherein dⱼ is the two-dimensional image provided in the plane of focus with coordinate z₀.

7. The method according to claim 5, comprising the operation of:
through a Singular Value Decomposition operation performed on the N supplied images dⱼ, determining said third term I^{oof(k)}(x, y, z₀) constant at each k-th iteration step as a common component to all the N supplied images dⱼ.

8. A computer program, comprising software code configured so that, when executed by a computer, causes the computer to execute the method according to claim 1.

9. A structured illumination microscopy method for viewing a super-resolution reconstructed image of a fluorescent sample comprising fluorophores that emit light when illuminated with an excitation light beam, comprising:
illuminating said sample with a plurality of excitation light beams focused in a secant plane traversing said fluorescent sample to excite at least a portion of said fluorophores in the sample;
for each j-th beam of excitation light focused in said secant plane, capturing a related two-dimensional image dⱼ in the secant plane of the distribution of excited fluorophores of the sample;
generating with a computer a file of a super-resolution reconstructed image of said sample by the method of claim 1; and
displaying on the screen said super-resolution reconstructed image.
